(19) United States
(12) Patent Application Publication
(10) Pub. No.: US 2011/0095710 A1
(43) Pub. Date: Apr. 28, 2011

(54) METHOD FOR CONTROLLING AN ELECTRIC DISCONNECTING SWITCH MOTOR

(75) Inventors: Franck Guillon, Grenoble (FR); Norbert Rozand, Maillat (FR)

(73) Assignee: Societe Dauphinoise De Constructions Electro-Mecaniques, Fif (FR)

(21) Appl. No.: 12/994,631

(22) PCT Filed: May 25, 2009
(86) PCT No.: PCT/FR2009/050964

§ 371 Date: Nov. 24, 2010

(30) Foreign Application Priority Data
Jun. 3, 2008 (FR) 0853660

(51) Int. Cl. H01H 3/26

(52) U.S. Cl. 318/3

(57) ABSTRACT

Device for controlling an electric disconnecting switch motor, including a power supply circuit for supplying power to motor from a network voltage source, said circuit including a static converter controlled to output a voltage having a predetermined value to motor; and one or more configuration components, the actuation of which enables the configuration of said circuit with a view to setting the direction of the current (i) that flows in motor, characterised in that control of static converter and control of configuration components are provided by two separate control units, each outputting control instructions, the control instructions of one of the two control units being activated on the basis of a validation instruction from the other control unit.

### CROSS REFERENCE TO RELATED APPLICATIONS

This application is a National Stage filing under 35 U.S.C. §371 of PCT Application No. PCT/FR2009/050964, filed on May 25, 2009. This application also claims the benefit of French Application No. 0853660, filed Jun. 3, 2008. The entirety of both applications is incorporated herein by reference.

### FIELD OF THE INVENTION

The present invention relates to a device for electrically controlling the operation of an electric disconnecting switch. It relates, more particularly, to the way in which the various operating-related operations are devised and coordinated, namely powering the electric motor and determining the direction of rotation of that same motor.

### BACKGROUND OF THE INVENTION

Generally speaking, in order to control opening and closing of a disconnecting switch, one uses an electric motor that acts on the moving components of the disconnecting switch through a gear reduction mechanism. When the motor is driven for a sufficient duration, it thus makes it possible to ensure displacement of the moving parts of the disconnecting switch in order to cause it to open or close.

More precisely, the direction of movement of the moving parts of the disconnecting switch is set by the configuration of the motor's power supply circuit. A set of appropriate relays makes it possible to reverse the direction in which the coil of the motor is connected relative to the voltage source that provides the energy required for operation. More precisely, this reconfiguration of the circuit can be obtained by using electromechanical components of the relay or analogue type that are appropriately controlled, depending on opening/closing control instructions requested by the user.

The Applicant has described a control device which it has developed that has applications for controlling disconnecting switches in Document FR2904469.

More precisely, this control device is suitable for ensuring that a single motor having a specified rated voltage can be used by being controlled by various types of AC or DC mains voltages and different voltages. To achieve this, the power supply circuit for supplying power to the motor includes a static converter that makes it possible to output the rated voltage of the motor regardless of the mains voltage. The static converter can, for example, use a modulation or Pulse Width Modulation (PWM) mechanism. This static converter is controlled by a control unit that includes a microcontroller that outputs appropriate instructions, firstly, to the relay circuitry that ensures configuring of the circuit and therefore the direction of current flow and, secondly, to the static converter so that it outputs the desired voltage.

It is known that a disconnecting switch is an electrical apparatus that has virtually no interrupting capacity and that it is therefore absolutely essential to prevent any on-load opening of the disconnecting switch which could damage its cut-off members. Similarly, for obvious safety reasons, it is absolutely imperative to ensure that the disconnecting switch cannot close inadvertently.

However, controlling the static converter by means of a microcontroller does involve minimal risk of accidentally controlling the disconnecting switch if the microcontroller is in an inconsistent operating state.

Thus, if the outputs of the microcontroller that are designed to control the static converter are in an active state, i.e. a state that makes it possible to supply power to the motor, and, moreover, the electromechanical components for configuring the circuit allow the flow of current to the motor, the latter can be powered in situations where it should not be.

In fact, for example, in the case of interference caused by strong electromagnetic fields, the microcontroller may have its outputs forced to a specific state or a state that is inconsistent with its programmed operation.

In this case, the mains voltage obtained directly from the power supply network can be applied to the motor, possibly after rectification if it is an AC voltage network.

In most cases, this voltage is higher than the rated voltage of the motor and therefore causes a current increase that exceeds the threshold for triggering protective devices. Nevertheless, in the particular case where the rated voltage of the motor corresponds to the mains voltage, rectified if applicable, such thermal cut-outs are not triggered and the motor is then powered, thus causing inadvertent operation of the disconnecting switch.

One of the objectives of the invention is to prevent this type of accidental operation which may pose significant safety risks.

### SUMMARY OF THE INVENTION

The invention therefore relates to a device for controlling an electric disconnecting switch motor. This device includes a power supply circuit for supplying power to the motor from a network voltage source. This circuit includes a static converter controlled to output a voltage having a predetermined value to the motor through control instructions output by a main control unit.

According to the invention, this device is characterised in that it comprises an additional control unit with which the main control unit communicates. The control instructions from the main control unit are activated on the basis of a validation instruction from the additional control unit.

In other words, the invention involves controlling the static converter that powers the motor through an electronic component (or, generally speaking, a set of components) that does not act only on the static switch but requires confirmation of its correct operation by another control unit that is responsible for validating correct operation of the main unit. Thus, applying these instructions requires two commands realised by separate units. The probability of both these units simultaneously assuming inconsistent states in which the static converter enables the flow of current and the circuit used to verify the additional unit validates inconsistent instructions is extremely low.

In fact, the electromechanical configuration components are designed so that the motor is not connected to the voltage source and the static converter when no control signal is present, i.e. in the idle state.

Advantageously and in practice, each control unit may consist of a microcontroller, a first microcontroller ensuring control of the static converter whereas the other microcontroller outputs instructions to validate commands from the static converter confirming that the main control unit is operating correctly.

One of the two microcontrollers assumes the role of master and the other microcontroller is in a slave configuration so that the instructions that it generates are not activated and therefore applied to the static converter unless the other microcontroller authorises this.

In practice, the control instructions for the static converter used to adjust the voltage applied to the motor can preferably be a pulse width modulation (PWM) system so that the voltage applied to the motor corresponds to its rated voltage thanks to a predetermined duty cycle.

In practice, these PWM instructions can be output to a static switch, the control circuit of which has one terminal connected to the main control unit that outputs PWM instructions and another terminal connected to the additional control unit. This way, the switch can only be closed if both the control units are operating correctly. In this case, the static converter is actually controlled by one microcontroller when the other microcontroller authorises this.

The two microcontrollers exchange signals using a predetermined protocol so that they can receive and confirm validation instructions. Thus, if the first microcontroller does not receive any signal confirming correct operation of the second microcontroller, the validation instructions are inoperative and the static converter is not controlled.

In one embodiment, it is possible for the static converter to be controlled by the master microcontroller which also acts on the electromechanical components for configuring the circuit and, in particular, the components whose actuation is used to set the direction of the current that flows in the motor.

According to another aspect of the invention, it is advantageous that the control unit that receives a validation instruction is only supplied with power during phases when this validation instruction is output. In other words, the slave microcontroller of the main unit is only powered during phases when it must send instructions intended for the components that it controls. Thus, if the static converter receives instructions from a slave microcontroller, the latter is only powered up during phases when the motor actually has to be activated.

This way it is possible to limit the risk of the slave microcontroller malfunctioning and to limit electrical power consumption.

According to another aspect of the invention, in order to limit the risk of both microcontrollers malfunctioning simultaneously, it is preferable that they each have a clock that is independent of the other controller and, advantageously, operate using technologies that are different from quartz crystal or RC type technology, for example.

In one particular embodiment, the control instructions for the static converter and the instructions intended for the configuration components of the circuit can be generated by the same control unit, typically the same microcontroller.

In other words, the “master” microcontroller ensures all management of operation of the disconnecting switch, including determining the motor-current direction and generating the appropriate PWM instructions. The slave microcontroller communicates with the master microcontroller and outputs the validation instruction if it is capable of detecting that the master microcontroller is actually in a normal operating mode. The second microcontroller therefore acts as an interlock in order to ensure that the instructions output by the main microcontroller are consistent.

### BRIEF DESCRIPTION OF THE DRAWINGS

The way in which the invention is realised and its resulting advantages are clearly apparent from the description of the particular embodiment which follows, reference being made to the appended single FIGURE which is a simplified circuit diagram showing the circuit for supplying power to the motor of a disconnecting switch and some of the associated control components.

### DETAILED DESCRIPTION OF THE INVENTION

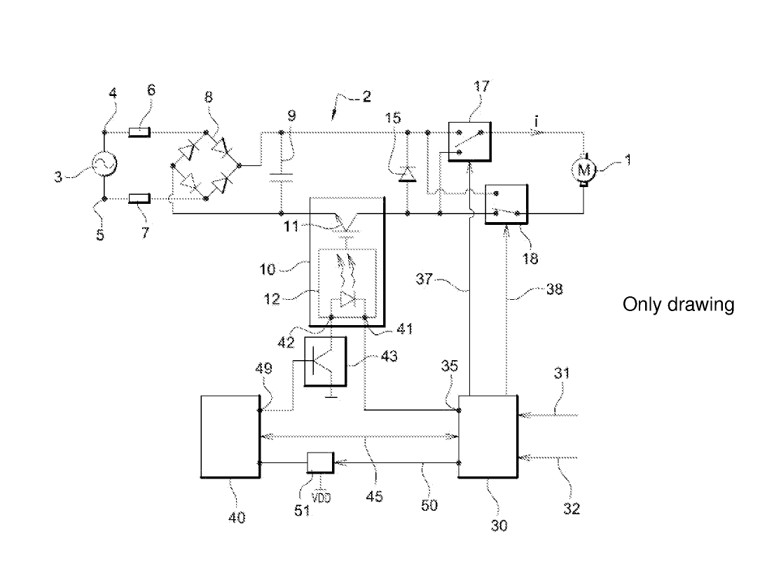

As shown in FIG. 1, motor (1) of the disconnecting switch is powered by circuit (2) that is connected to a network voltage source (3) which, in the embodiment illustrated, is an AC voltage source. Circuit (2) therefore comprises, through connections (4, 5) to the AC circuit, a set of fuses (6, 7) connected to rectifier (8) in the form of a diode bridge which outputs a voltage that is substantially constant across the terminals of capacitance (9).

Downstream from capacitance (9), there is a voltage chopper setup that comprises power converter (10) which includes static switch (11), of the IGBT type for instance, connected in series with motor (1) and freewheel diode (15).

Downstream from this freewheel diode (15), there are two relays (17, 18) that function as components used to configure the circuit for supplying power to the motor (1). The current-flow direction in the motor is set depending on the position of the contact of relays (17, 18).

In the embodiment illustrated which corresponds to the idle positions, the motor is short-circuited. Also, when the contact of relay (17) is energised by signal (37) in order to change position, the motor is connected to the voltage source in such a way that current (I) that flows through it is positive. Conversely, when the contact of relay (18) changes position in response to instruction (38), the current (I) that flows through the motor is negative.

Actuation of the two relays (17, 18) is obtained via microcontroller (40) which receives open instructions (31) or close instructions (32) from the control board or, more generally speaking, the system for managing operation of the disconnecting switch.

Depending on AC network voltage (3), microcontroller (40) also computes the duty factor and PWM control instructions that must be applied to static converter (10) in order to obtain the desired voltage across the terminals of motor (1).

More precisely and according to one aspect of the invention, static converter (10) control is obtained through two microcontrollers (30, 40). In the embodiment illustrated, static switch (11) is shown as being associated with optoelectronic component (12). Other components or arrangements may, obviously, be used schematically in an equivalent manner.

Thus, cathode (41) of optoelectronic component (12) is connected to additional control unit (30), whereas anode (42) is connected to main control unit (40).

It is therefore necessary that both microcontrollers (30, 40) operate correctly in concerted fashion in order to ensure correct control of static switch (11). Thus, the two microcontrollers (30, 40) are connected by a hardwired link (45) so that they can communicate on the basis of a specific protocol.

The communication protocol may vary depending on the level of security that is to be implemented. In a developed embodiment, it may be preferable for communication to be encrypted, i.e. by swapping a code that consists of a large number of bits, for example 32 bits. As shown in the FIGURE, power can be supplied to additional microcontroller (30) and it can be controlled via main microcontroller (40) which, when necessary, sends signal (50) to component (51) which is used to supply power to additional microcontroller (30).

This type of arrangement makes it possible, for example, to use microcontrollers that have different power supply voltages.

Operation of the system can be summarised as follows.

When main microcontroller (40) receives an open or close instruction (31, 32), it activates the supply of power to additional microcontroller (30) through signal (50). If additional microcontroller (30) is operational, it communicates with main microcontroller (40) over hardwired link (45).

If the dialogue is satisfactory and in conformity with the predetermined protocol, output (35) of the monitoring microcontroller is set to a state that makes it possible to ground cathode (41) of component (12) that is used to control static switch (11).

Then, main microcontroller (40) energises direction relay (17, 18) in order to set the direction of the current that flows through the motor. Then, after a timeout, main microcontroller (30) outputs PWM control instructions to the anode of component (12) via transistor (43) in order to ensure switching of static switch (11).

If main microcontroller (40) becomes uncontrollable and keeps its output (49) high, communication with additional microcontroller (30) flags up this abnormal operation. In this case, output (35) of additional microcontroller (30) changes to a state which is such that cathode (41) of electronic component (12) is disconnected from ground, therefore preventing control of static switch (11). There is therefore no longer any risk of the motor being controlled, despite the uncontrolled operating state of main microcontroller (40).

Conversely, if additional microcontroller (30) starts to operate inconsistently and, for example, leaves its output (35) in an active state, i.e. a state where cathode (41) of optoelectronic component (12) is grounded, communication between the two microcontrollers can no longer take place correctly and main microcontroller (40) then interrupts control of the static switch by leaving its output (49) in a low, inactive state.

At the end of this operation, main microcontroller (40) interrupts the transmission of PWM instructions and then deenergises direction relay (17, 18) and, finally, switches off the power supply to monitoring microcontroller (30).

Obviously, the various links and components shown schematically in the FIGURE are indicated merely by way of example and can be realised in different ways without extending beyond the scope of the invention as long as the principle of the invention continues to be applied.

The above descriptions show that the control device according to the invention has the advantage of ensuring extreme reliability in terms of controlling the motor of the disconnecting switch and does so through two microcontrollers that ensure control of the static converter and monitor each other.

1. Device for controlling a motor of an electric disconnecting switch, comprising a power supply circuit for supplying power to motor, from network voltage source, said circuit including a static converter controlled to output a voltage having a predetermined value to motor through instruction orders output by a main control unit an additional control unit with which main control unit communicates, the control instructions orders of main control unit being activated on the basis of a validation instruction from additional control unit.

2. Device as claimed in claim 1, wherein the main control unit and the additional control unit comprises a microcontroller.

3. Device as claimed in claim 1, wherein the static converter is controlled by pulse width modulation instructions.

4. Device as claimed in claim 3, wherein the pulse width modulation instructions are output to static switch, the control circuit of which has one terminal that is connected to control unit that outputs pulse width modulation instructions and another terminal that is connected to additional control unit.

5. Device as claimed in claim 1, wherein additional control unit is only powered during phases when the validation instruction is output.

6. Device as claimed in claim 1, wherein the two control units each have their own clock.

7. Device as claimed in claim 1, wherein the two control units communicate in order to receive and confirm the validation instruction.

8. Device as claimed in claim 1, wherein communication between the two control units is encrypted.

9. Device as claimed in claim 1, further comprising one or more configuration components, the actuation of which enables the configuration of the power supply circuit for supplying power to the motor with a view to setting the direction of the current (i) that flows in motor and wherein the instructions intended for configuration components are provided by the control unit that provides the control instructions for static converter.
